(19) United States
(12) Patent Application Publication
(10) Pub. No.: US 2003/0046385 A1
(43) Pub. Date: Mar. 6, 2003

(54) User-side tracking of multimedia application usage within a web page

(75) Inventor: Marcus Vincent, Portland, OR (US)

Correspondence Address: MARGER JOHNSON & McCOLLOM, P.C., 1030 SW Morrison Street, Portland, OR, 97205, US

(73) Assignee: NetIQ Corporation, a Delaware Corporation, San Jose, CA

(21) Appl. No.: 10/123,890

(22) Filed: Apr. 15, 2002

Related U.S. Application Data
(60) Provisional application No. 60/283,858, filed on Apr. 13, 2001.

(51) Int. Cl. G06F 15/173

(52) U.S. Cl. 709/224; 709/217

(57) ABSTRACT

The operation of multimedia applications, such as Macromedia's Flash, embedded within a web page and downloaded by a visitor computer is tracked by using data mining code operating within the multimedia application, or by such code in conjunction with an interface within the web page. Each operation of the web page triggers a URL page request to a data tracking server that is coupled over a wide area network to the visitor computer and to the server from which the web page is downloaded. An example of such a trigger is a getURL command which, when activated, can be used to track such items as multimedia functions used within the multimedia application, pages viewed, scenes viewed, etc. The URL page request includes within the request data that is compiled by the data mining code at the visitor computer and arranged so that the raw data can be reconstituted at the data tracking server and compiled into reports accessible to the web page operator.

### CROSS-REFERENCES TO RELATED APPLICATIONS

This application claims the benefit from U.S. Provisional Patent Application No. 60/283,858 filed Apr. 13, 2001 whose contents are incorporated herein for all purposes.

### BACKGROUND OF THE INVENTION

1. Field of the Invention

The present application relates to compiling and reporting data associated with activity on a network server and more particularly to compiling and reporting data associated with the viewing of web page content over the worldwide web.

2. Description of the Prior Art

Programs for analyzing traffic on a network server, such as a worldwide web server, are known in the art. One such prior art program is described in commonly owned U.S. Pat. No. application Ser. No. 09/240,208, filed Jan. 29, 1999, for a Method and Apparatus for Evaluating Visitors to a Web Server, which is incorporated herein by reference for all purposes. In these prior art systems, the program typically runs on the web server that is being monitored. Data is compiled, and reports are generated on demand—or are delivered from time to time via email—to display information about web server activity, such as the most popular page by number of visits, peak hours of website activity, most popular entry page, etc.

Analyzing activity on a worldwide web server from a different location on a global computer network (“Internet”) is also known in the art. To do so, a provider of remote web-site activity analysis (“service provider”) generates JavaScript code that is distributed to each subscriber to the service. The subscriber copies the code into each web-site page that is to be monitored. When a visitor to the subscriber's web site loads one of the web-site pages into his or her computer, the JavaScript code collects information, including time of day, visitor domain, page visited, etc. The code then calls a server operated by the service provider—also located on the Internet—and transmits the collected information thereto as a URL parameter value. Information is also transmitted in a known manner via a cookie.

Each subscriber has a password to access a page on the service provider's server. This page includes a set of tables that summarize, in real time, activity on the customer's web site.

Modem web site traffic analysis tools have been useful for tracking page-to-page navigation, e.g. where a visitor downloads one page and then clicks a link to transition to another page. Each click of a link causes the web browser to send a request over the Internet for the new web page, which is then downloaded from the web page server storing the web page and loaded within the browser running on the visitor's computer. The operation of conventional browsers such as Microsoft's Internet Explorer and Netscape Navigator are well known in the art. The active JavaScript within these pages reports back information every time a new page is loaded into the visitor computer's web browser.

Recently, applications such as Flash from Macromedia, Inc. have been developed to run within web pages. These applications include their own navigation tools and have multiple viewable pages that operate within a single web page. An entire Flash-based presentation might therefore exist only on at single web page address where the user “browses” within the flash presentation. Clicks within the flash presentation do not result in requests being sent back to the web page server since the entire presentation is already downloaded to the visitor computer. Because a visitor is no longer operating with page-to-page navigation when viewing a flash presentation, modem web page tracking tools have been unable to track browsing within these type of applications.

Accordingly, the need remains for system and method for overcoming this drawback in the prior art.

### BRIEF DESCRIPTION OF THE DRAWINGS

The foregoing and other objects, features and advantages of the invention will become more readily apparent from the following detailed description of a preferred embodiment of the invention that proceeds with reference to the accompanying drawings.

FIG. 1 is a highly schematic view of a portion of the Internet implementing the present invention.

FIGS. 2 and 3 are representative pages of a multimedia presentation capable of being tracked by the methods of the present invention.

FIGS. 4 and 5 are representative pages of an embedded flash presentation capable of being tracked by the methods of the present invention.

FIG. 6 is a high-level block diagram illustrating the operation of a web page with a tracking reporting server according to a preferred embodiment of the invention.

FIG. 7 is a flow chart that depicts a preferred operation of the invention.

### DETAILED DESCRIPTION

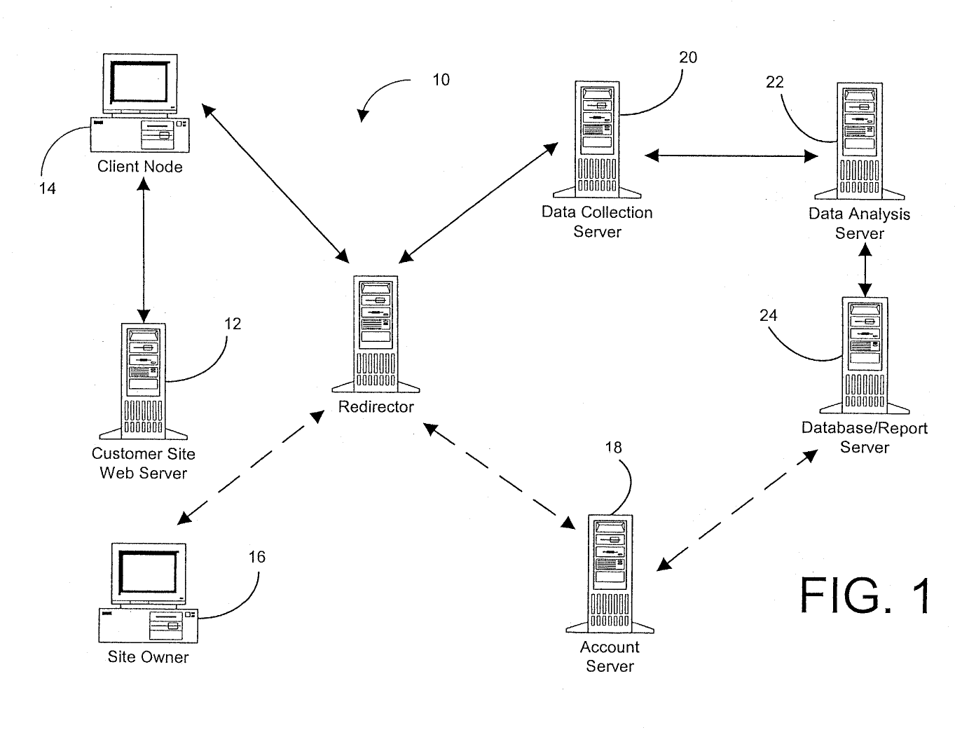

Turning now to FIG. 1, indicated generally at 10 is a highly schematic view of a portion of the Internet implementing the present invention. Included thereon is a worldwide web server 12. Server 12, in the present example, is operated by a business that sells products via server 12, although the same implementation can be made for sales of services via the server. The server includes a plurality of pages that a site visitor can download to his or her computer, like computer 14, using a conventional browser program running on the computer. Examples of the type of pages that a visitor can download include informational pages and pages that describe the business and the products or services that are offered for sale.

As mentioned above, it would be advantageous to the seller to have an understanding about how customers and potential customers use server 12. As also mentioned above, it is known to obtain this understanding by analyzing web-server log files at the server that supports the selling web site. It is also known in the art to collect data over the Internet and generate activity reports at a remote server.

When the owner of server 12 first decides to utilize a remote service provider to generate such reports, he or she uses a computer 16, which is equipped with a web browser, to visit a web server 18 operated by the service provider. On server 18, the subscriber opens an account and creates a format for real-time reporting of activity on server 12.

To generate such reporting, server 18 provides computer 16 with a small piece of code, typically JavaScript code. The subscriber simply copies and pastes this code onto each web page maintained on server 12 for which monitoring is desired. When a visitor from computer 14 (client node) loads one of the web pages having the embedded code therein, the code passes predetermined information from computer 14 to a server 20—also operated by the service provider—via the Internet. This information includes, e.g., the page viewed, the time of the view, the type of browser used, the visitor's identification, etc. Server 20 in turn transmits this information to an analysis server 22, which is also maintained by the service provider. This server analyzes the raw data collected on server 20 and passes it to a database server 24 that the service provider also operates.

When the subscriber would like to see and print real-time statistics, the subscriber uses computer 16 to access server 18, which in turn is connected to database server 24 at the service provider's location. The owner can then see and print reports, like those available through the webtrendslive.com reporting service operated by the assignee of this application, that provide real-time information about the activity at server 12.

The above-described arrangement for monitoring web server activity by a service provider over the Internet is generally known in the art. Information analyzed in prior art systems generally consists of what might be thought of as technical data, such as most popular pages, referring URLs, total number of visitors, returning visitors, etc. One piece of information that is useful to but is not provided to a site owner is how long a page takes to load on a visitor's computer 14. If page loads are taking too long, then a web site operator can redesign the page to load faster and/or add new web page server equipment to make the site more responsive to user requests.

Modern web browsers such as Internet Explorer (IE) and Netscape Navigator operate to send for, retrieve and load web pages. A common method for implementing web pages is to use html or JavaScript code, which is interpreted by the web browser and implemented on the computer requesting the web page and including the web browser program. A common feature of modem web browsers is the use of events to trigger or “fire” operations called an “Event Handler”. For example, moving a mouse cursor over a predefined hotspot or button on a web page can trigger a “mouseover” event. The triggering of such an event can be used by such browser plug in technologies as Flash (created by Macromedia, Inc.) to run a subroutine that changes the hotspot from one graphic to another.

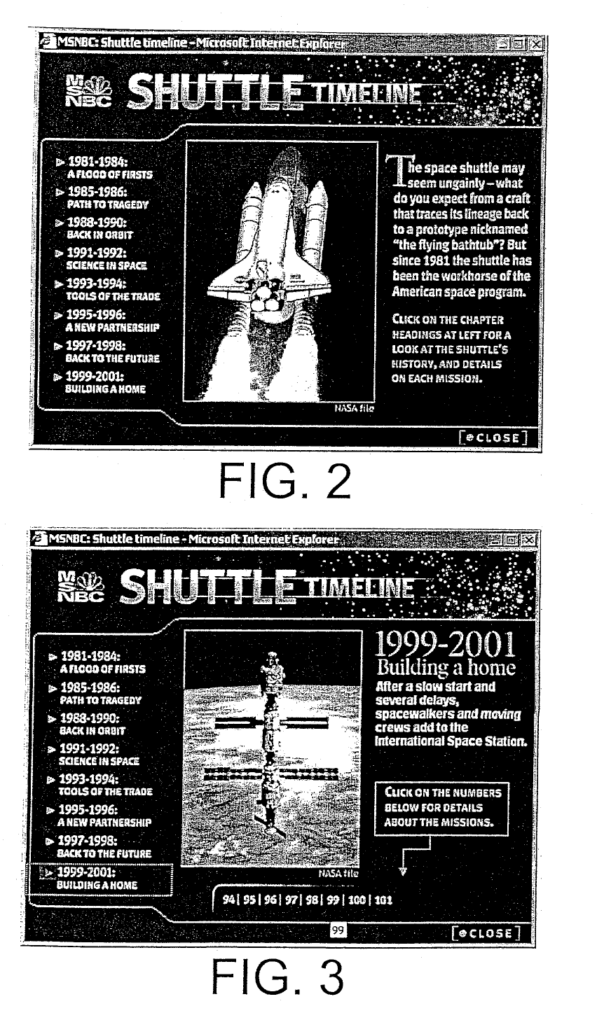

FIGS. 2 and 3 illustrate an example of one multimedia presentation that is running outside of and in a separate window from the browser application. The window displayed in FIG. 2 illustrates the default page of the presentation running on the visitor's computer implemented using Flash technology. The central portion of the window displays a picture accompanying the informational content of the presentation default page. Along the right side of the window is a short informational paragraph about the space shuttle with instructions to click on the chapter headings at the left for a look at the shuttle's history and details of each mission. Along a left side of the window are various selections, such as the one titled “1999-2001: Building A Home”, that a visitor can click on to change the window display to that shown in FIG. 3.

FIG. 3 illustrates one page of the flash presentation selected by the visitor browsing by using the browsing buttons along the left side of the flash presentation window. The visitor can browse further within the presentation by clicking on any of the numbers located along the bottom center of the window. In the figure shown, the computer cursor has been moved via mouse until it is positioned over the “99” button. If a visitor were to click on that button, the flash presentation window would change to present further information about shuttle mission 99. As the entire flash presentation is loaded in the visitor computer, traditional web tracking tools using new page requests calls from the web browser, cannot be used to track visitor browsing within the presentation. Statistics on which shuttle mission might be most popular with readers, for instance, would be unavailable for analysis.

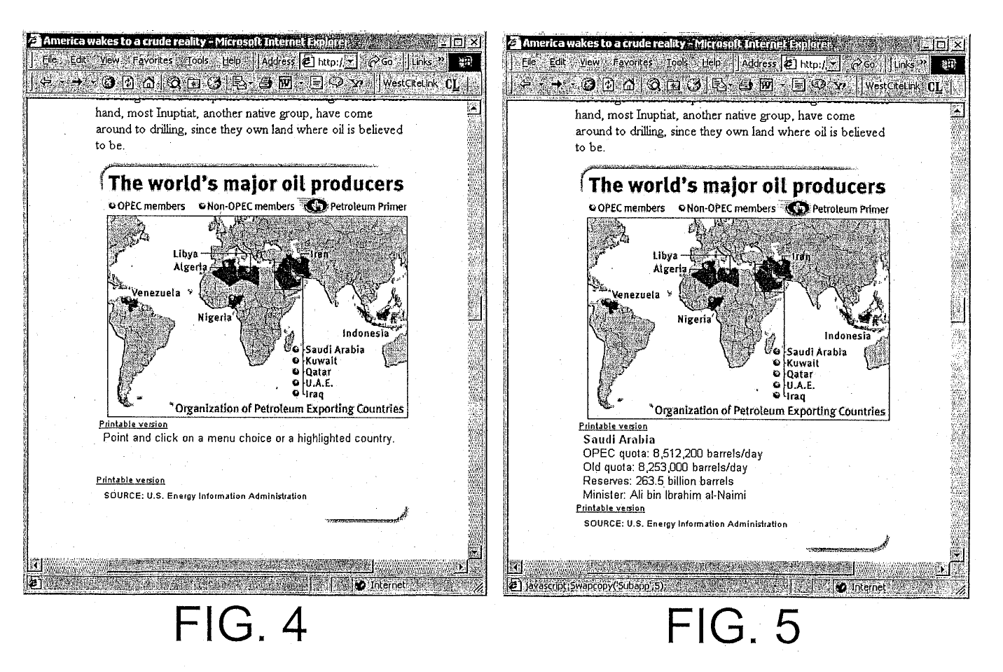

FIGS. 4 and 5 illustrate a multimedia flash presentation that is embedded within a web browser. The FIG. 4 screen shot illustrates the default page of the presentation with the instructions for the visitor to point and click on a menu choice or highlighted country. The FIG. 5 screen shot illustrates the presentation when the country “Saudi Arabia” is clicked to thereby present the same world map but with Saudi Arabian oil production statistics listed below. As with the flash presentation shown in FIGS. 2 and 3, the presentation within FIGS. 4 and 5 is completely downloaded into the visitor's computer and operated from there. No call requests are made back to the web page server thus preventing any tracking of browsing within the multimedia viewer to occur using conventional means. Thus, the site operator would be unable using prior art techniques to determine which countries the visitor is most interested in learning about.

Internet-capable applications have the capability of communicating real-time to a central server which can record customer-defined information. Internet-capable applications are defined as (1) Web browsers, (2) WAP and Palm Devices, and (3) Windows or other operating system applications.

What information is monitored/tracked is up to the developer of the application. Examples of information that could be tracked are things such as Operating System, days used, area of application being utilized, number of minutes application was open, search phrases used, etc. Various services such as those available at webtrendslive.com allow the monitoring of application activity through the use of HTTP requests to the reporting servers. Any application, web or Windows-based (non-OS specific) that can take advantage of the HTTP protocol is able to send monitoring information to WebTrends Live reporting servers.

The technology used to gather and report information of visitors to a particular web page is fairly well known. A customer (user of the service and operator of the web pages being tracked) pastes JavaScript code into the html code of each of the web pages they desire to have tracked. The pasted JavaScript code is then downloaded with the web page and runs on the browser of the visitor's computer to carry out data gathering and reporting services. Modern web pages include graphics embedded within the text of the web page. These graphics are usually downloaded separately from the web page by making a “call” to a particular file and server where the graphic is located.

Use of this feature within web pages is used as follows. Services such as WebTrends Live embed a tiny graphic (one pixel by one pixel in size) within the web page whose location is listed as being on one of WebTrends Live servers. This graphic is made small so as not to appear to the naked eye on the web page. The location or “source” of the graphic image includes a variable that is defined by the data gathered about the visitor's computer. The WebTrends Live-supplied JavaScript includes code that gathers information about the visitor and codes the information into the variable. The WebTrends Live servers include a program that interprets this code when it receives requests from the visitor computer for the 1×1 pixel graphic image.

By setting the source of the image to a variable built by the script (e.g. www.webtrendslive.com/button3.asp?id39786c45629t120145), all the gathered information can be passed to the web server doing the logging. In this case, for instance, the variable script “id39786c45629T120145” is sent to the webtrendslive.com web site and is interpreted by a decoder program built into the data analysis server to mean that a user with ID#39786, loaded client web site #45629 in 4.5 seconds and spent 1:20 minutes there before moving to another web site. This is just an example of the types of data that can be transmitted using this method and it is understood that many other types of information can be tracked and reported.

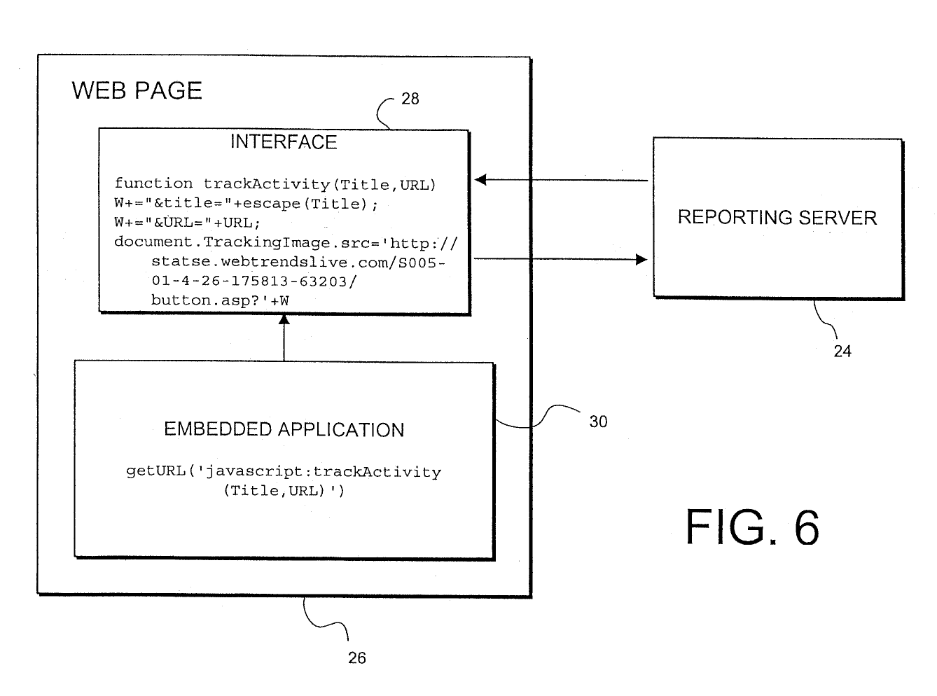

FIG. 6 is a schematic representation of the interaction between the JavaScript interface 28 supplied by the tracking service providor and pasted by the web page owner/customer into each web page, the embedded (e.g. Flash) application 30 within the web page 26, and the reporting server 24 that receives and compiles the user data information from the visitor.

Per the operation of a preferred method, the embedded application 30 includes a piece of code that calls out from the application to the interface 28. In the example shown, the embedded application code utilizes a function available within Flash called the getURL command. The full text of the command is as follows:

getURL(‘javascript:trackActivity(Title,URL)’)

, where the title of the particular flash page viewed and the location of the presentation is stored in variables ‘Title’ and ‘URL’. The variables shown are simply shown as examples and those skilled in the art would recognize that variables for any two parameters can be tracked. Functions of the multimedia application that can be tracked are visitor clicks on play button, visitor clicks on stop button, new screen (e.g. product page), pages viewed, scenes viewed, etc.

In the browser-based interface of FIG. 6, embedded application 30 within web page 26 communicates to hosting parent page 12 (FIG. 1), which then communicates to central server the originating application's request. Methods of communication between application and parent page involve JavaScript or COM. With the custom HTTP-based request, the tracking service provider uses standard server log files that are generated by requests to the server. Any application that can generate a GET or POST request can then communicate with the tracking service servers. The request can come from any application, not just web-browsers. During the request to the client application would append either in the data section of a POST or the URL of a GET request the parameters that the application would like to monitor.

A sample implementation of the invention is now described using the following source code embedded within the web page being tracked, where the web page includes (1) a Communication interface (trackActivity( )) to the tracking service servers, (2) an embedded Flash/Shockwave movie (flashmovie.swf), and (3) JavaScript code to extract browser information.

| | |
|---|---|
| 1) | <HTML> |
| 2) | <BODY> |
| 3) | <IMG Name =“TrackingImage” width = “1” height = “1” ID = |
| | “TrackingImage” SRC = “blank.gif”> |
| 4) | <SCRIPT LANGUAGE=“JavaScript”> |
| 5) | |
| 6) | function trackActivity(Title,URL) |
| 7) | { |
| 8) | var ORDER=“ ”; |
| 9) | var SERVER=“ ”; |
| 10) | var CONTENTGROUP=“ ”; |
| 11) | |
| 12) | |
| 13) | var W=“tagver=3&SiteId=63203&Sid= |
| | 005-01-3-26-175813-63203&Tz=− |
| | 800&firstwkday=sunday&Edition=personal&Button=10”; |
| 14) | W+=“&server=”+escape(SERVER); |
| 15) | W+=“&order=”+escape(ORDER); |
| 16) | W+=“&Group=”+escape (CONTENTGROUP); |
| 17) | W+=“&browserDate=”+escape (new Date ( )); |
| 18) | w+=“&title=”+escape(Title); |
| 19) | W+=“&url=”+URL; |
| 20) | W+=“&referrer=”+window.document.referrer; |
| 21) | W+=“&appname=”+escape (navigator.appName); |
| 22) | W+=“&appversion=”+escape (navigator.appVersion); |
| 23) | W+=“&cookieOK=”+(navigator.cookieEnabled? “Yes”:“No”); |
| 24) | W+=“&userLanguage=”+(navigator.appName== |
| | “Netscape”?navigator.langua |
| | ge:navigator.userLanguage); |
| 25) | W+=“&platform=“+navigator.platform; |
| 26) | W+=“&bgColor=”+escape(document.bgColor); |
| 27) | W+=“&javaOK=Yes”; |
| 28) | if(typeof(screen)==“object”) |
| 29) | { |
| 30) | W+=“&screenResolution=”+screen.width+“x”+screen.height; |
| 31) | W+=“&colorDepth=”+screen.colorDepth; |
| 32) | W+=“&NSpluginList=”; |
| 33) | for( var i=0; i< navigator.plugins.length; i++) |
| 34) | W+=escape(navigator.plugins[i].name)+“;”; |
| 35) | } |
| 36) | |
| 37) | document.TrackingImage.src = |
| | ‘http://statse.webtrendslive.com/S005- |
| | 01-3-26-175813-63203/button3.asp?’+W; |
| 38) | |
| 39) | } |
| 40) | |
| 41) | </SCRIPT> |
| 42) | |
| 43) | <OBJECT classid=“clsid: |
| | D27CDBGE-AE6D-11cf-96B8-444553540000” |
| | codebase=“http: |
| | //download.macromedia.com/pub/shockwave/cabs/flash/s |
| | wflash.cab#version=5,0,0,0” WIDTH=775 HEIGHT=580> |
| 44) | <PARAM NAME=movie VALUE=“flashmovie.swf”> |
| 45) | <PARAM NAME=quality VALUE=high> |
| 46) | <PAPAM NAME=scale VALUE=showall> |
| 47) | <PARAM NAME=bgcolor VALUE=#FFFFFF> |
| 48) | <EMBED src= |
| | “fl.swf” quality=high bgcolor=#262c38 SCALE=showall |
| | TYPE=“application/x-shockwave-flash” |
| | PLUGINSPAGE=“http: |
| | //www.macromedia.com/shockwave/download/index.cgi |
| | ?P1_Prod_Version=ShockwaveFlash”> |
| 49) | </EMBED> |
| 50) | </OBJECT> |
| 51) | |
| 52) | </BODY> |
| 53) | </HTML> |

Lines 3) of the above code is the image call made to the tracking service servers as described above. Line 13) establishes the identity of the web page including a customer code that identifies the user of the tracking services. Lines 14) to 34) operate to add coded information within a variable ‘W’ that identifies such information as browser application name and version, the screen resolution, color depth. The variable ‘W’ is added to the end of the document requested in line 37), ultimately being received by the tracking service provider's servers for decoding and reporting. Line 43) to 50) show the call to the embedded flash presentation flashmovie.swf.

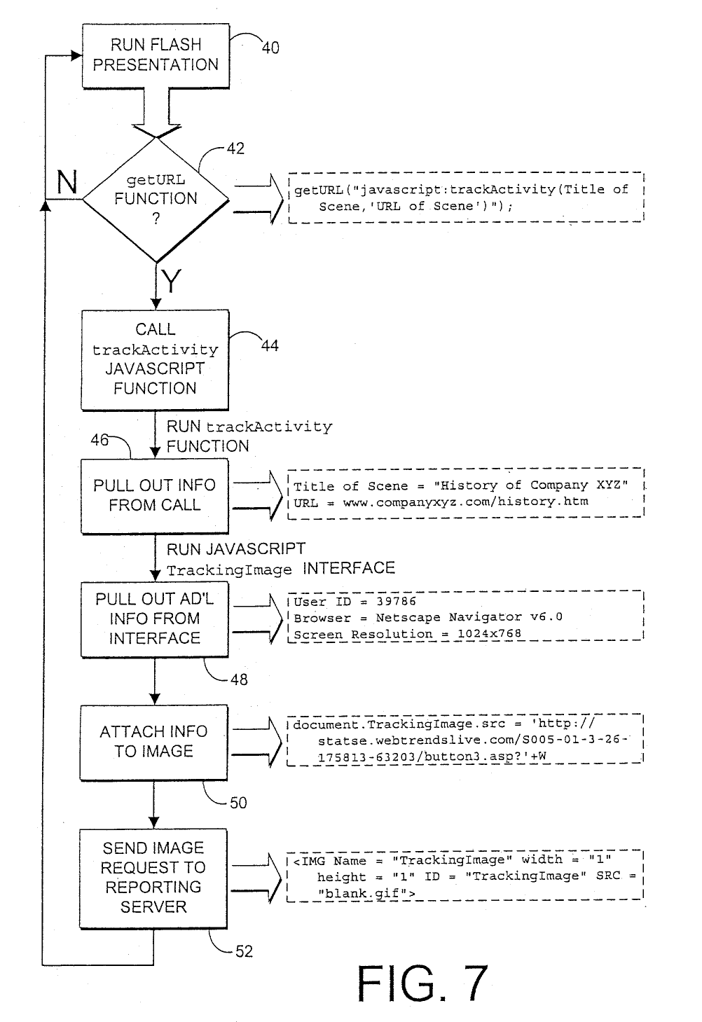

FIG. 7 is a flow chart illustrating the preferred method of operation of the invention. Once the visitor downloads the web page 26, including the JavaScript interface 28 and embedded application 30, the visitor chooses to run the application that can take the external form shown in the FIGS. 2 and 3, or the integrated form of FIGS. 4 and 5. Each version of the application 30 includes the getURL command that calls the trackActivity command contained within the interface 28.

Once the visitor runs the flash presentation in block 40, the presentation operates until it reaches a call command such as the getURL function in block 42. Operation of the getURL command calls out to the trackactivity function in block 44 listed in the getURL command. The trackActivity function is run to request to the hosted interface that it would like to track a specific area, here the title of the scene run (“History of Company XYZ”) and the URL of the scene (“www.companyxyz.com/history.htm”). This information is pulled out in block 46. The JavaScript in the host web page 26 runs to pull out the additional information, such as by operating the JavaScript code shown in lines 13) to 34) above. Note that lines 18) and 19) utilize the information extracted from the getURL command, thereby attaching the embedded application title and URL respectively to the image request. The interface takes the tracking information from the application and coded within the image and creates a formal request to the reporting server 24. The image request, with attached coded information about the visitor computer and web content viewing data, is sent to the tracking services reporting servers in block 52.

It is contemplated within the invention that multiple requests to the tracking servers can be generated by any of the following means. First, the .SRC attribute of an image on the parent web page/frame can be updated with the URL of the new tracking request. Such a process can be implemented using the following code:

<SCRIPT LANGUAGE=‘Javascript’>
document.write(“<IMG NAME=
““TrackingImage”” HEIGHT=““1”” WIDTH=““1”” SRC““ ””

ID=““TrackingImage””>”);

function trackAction(URL)
{

document.TrackingImage.src = URL;

}
</SCRIPT>

A second means for making multiple requests is by writing to the parent document a new image whose .SRC attribute is the URL of the new tracking request. Such a process can be implemented using the following code:

<SCRIPT LANGUAGE=‘Javascript’>
document.write(“<IMG NAME=
““TrackingImage”” HEIGHT=““1”” WIDTH=““1”” SRC=““ ””

ID=““TrackingImage””>”);

function trackAction(URL)
{

document.all.items(“TrackingSection”).innerHTML =
“<IMG SRC = “+URL +”>

}
</SCRIPT>

A third means for making multiple requests is by opening a new browser window with the URL of the tracking request. After the request is made, the browser either stays open for further requests, or closes and can be reopened for the next request. A forth means is by way of an XML request from the embedded application made directly to the tracking service reporting servers as by using the following command:

myXML.Send(‘http://www.webtrendslive.com/tracking.asp’)

Finally, an HTTP GET/POST request can be made directly from the embedded application to the tracking service reporting servers. The tracking servers would receive the request from the application and generate a log file. The log file is then processed and the tracking server processed update the appropriate databases to reflect activity for the application.

An example of the last process is as follows. The Flash/Shockwave movie calls out to the interface that it would like to track the start of a scene called “History of Company XYZ.”, for a page called /history.htm. This step is implemented in the following code run within the Flash embedded application:

getURL (“javascript:trackActivity(‘History of Company XYZ’,‘http://www.companyXYZ.com/history.htm’)”);

The hosting page has a JavaScript function called trackActivity( ) which takes the request from the Flash/Shockwave application and communicates the request to reporting servers:

function trackAction(Title,URL)

{

//create request to reporting server

}

Either of these following commands then would open a new window and passes the parameters being tracked, P1 and P2, to the new page:

getURL(‘mydomain.com/settings.asp?P1=A&P2=B’,GET/POST)

getURL(“javascript:window.open(“trackingpage.htm?p1=A&p2=B”);

Having described and illustrated the principles of the invention in a preferred embodiment thereof, it should be apparent that the invention can be modified in arrangement and detail without departing from such principles.

What is claimed is:

1. A method for tracking and reporting traffic activity within an application embedded within a web page comprising the steps of:
storing a web page on a first server coupled to a wide area network, said web page having an application operating therein including data mining code;
uploading the web page to a visitor computer responsive to a request over the wide area network from the visitor computer;
operating the application under visitor control on the visitor computer;
operating the data mining code on the visitor computer; and
responsive to the data mining code, reporting activity on the application through the wide area network to a data reporting server.

2. The method of claim 1, wherein the application is a flash presentation and the data mining code includes a getURL command.

3. The method of claim 1, wherein the application is a flash presentation and the activity includes at least one selected from the group consisting of visitor clicks on play button, visitor clicks on stop button, new screen, pages, viewed and screens viewed.

4. The method of claim 1, further including the steps of:
embedding an image within the web page, said image having a first .SRC attribute associated therewith;
operating the data mining code on the visitor computer to yield visitor data;
compiling the visitor data into a URL request; and
updating the .SRC of the image to reflect the compiled URL request.

5. The method of claim 1, further comprising the steps of:
operating the data mining code on the visitor computer to yield visitor data;
compiling the visitor data into a URL request; and
creating an image whose .SRC attribute is associated with the URL request.

6. The method of claim 1 wherein the data mining code includes a myXML.send command.

7. The method of claim 1, further comprising the steps of:
storing an interface within the web page;
requesting to the interface that the operating of the application step be tracked; and
reporting the request from the interface to the reporting servers.
